(19) United States
(12) Patent Application Publication
(10) Pub. No.: US 2009/0240583 A1
(43) Pub. Date: Sep. 24, 2009

(54) Advertising system and method for providing targeted advertising in a communications network

(76) Inventor: Mark Hemphill, Charlottetown (CA)

Correspondence Address: FLYNN THIEL BOUTELL & TANIS, P.C., 2026 RAMBLING ROAD, KALAMAZOO, MI, 49008-1631, US

(21) Appl. No.: 12/231,018

(22) Filed: Aug. 28, 2008

(30) Foreign Application Priority Data
Mar. 19, 2008 (CA) 2 621 559

(51) Int. Cl. G06Q 30/00

(52) U.S. Cl. 705/14

(57) ABSTRACT

The present invention relates to an improved advertising network and system, which relates to interconnecting a plurality of venues through a network, each of the venues having at least one display panel or display screen for displaying advertisements and marketing materials to a plurality of users. Advertisers provide advertising preferences information (such as demographics preferences) in accessing the network, so as to locate a listing of pertinent venues, and display screens at these venues, where the particular demographic sought is found to be most prevalent. The present invention enables advertisers to identify, pinpoint and direct a targeted advertising display towards a specific subset of display screens or display panels at selected venues in an inter-connected network with a view to catering their advertising displays to a specific clientele (consistent with their advertising preferences information) in these selected venues.

### FIELD OF THE INVENTION

The present invention relates generally to an advertising system and network for interconnecting a plurality of venues through a network, and more particularly to an advertising system and network which pairs buyers and sellers of advertising space, whereby an advertiser can identify, pinpoint and direct an advertising display towards a specific subset of display screens at selected ones of the plurality of venues in the network with a view to catering to a specific clientele in the selected venues.

### DESCRIPTION OF THE PRIOR ART

Owners and operators of public facilities which double as public gathering places, which will also be referred to herein as “venues”, are increasingly recognizing the opportunities inherent in their position as a provider of strategic marketing messages, these messages being delivered to the public by means of display screens or display panels at these public facilities. Such establishments and institutions generally entertain a captive audience, and these can include, for example, restaurants and bars, car dealerships, conventional retail establishments, heath and fitness centers, office buildings, elevators, lobbies, lounges, vestibules, waiting rooms, corner stores, campuses and even street corners, if one considers the marketing potential of display screens present at Times Square in New York. In addition, display screens or display panels are increasingly becoming mobile, such as those used in the context of trade shows, sales displays, or even outdoor events.

As the cost of computers and screen technology continues to decrease, display screens and panels are becoming more and more commonplace, and available to be viewed by the public, in a multitude and wide ranging variety of locations, as noted above. Furthermore, as the connectivity and accessibility of even small establishments and businesses having these display screens or panels to wide ranging global networks (such as, for example, the Internet) continues to increase, the potential exists to provide an improved interconnected advertising network which can enable such establishments and businesses to create and manage intelligent custom screen displays for their clients or customers, and which pairs buyers and sellers of advertising space. In so doing, this can provide an opportunity for owners and operators of such establishments and businesses to add value to their existing business, by generating new revenue as sellers of advertising spaces. While presently, advertising networks do exist which allow for owners and operators of establishments and businesses to sell advertising space to generate revenue, opportunities are limited for advertisers to focus and concentrate their marketing efforts and advertising displays to a specific subset of display screens or panels at selected venues over an interconnected and linked communications network with a view to targeting their marketing and advertising efforts towards, and catering to, a specific clientele. For example, an advertiser may wish to focus and direct their marketing efforts over an interconnected network to a specific type of clientele, such as an audience of over-50 fitness oriented people in a specific geographic location, with a view to having display screens or panels at these locations advertise displays and marketing material catering to this targeted clientele.

Accordingly, there is a need for an improved advertising method and system which is able to interconnect a plurality of public gathering places (or “venues”), and which pairs buyers and sellers of advertising space, whereby an advertiser can identify, pinpoint and direct advertising displays and marketing materials towards a specific subset of display screens for showing at selected ones of the plurality of venues over an interconnected and linked communications network with a view to catering to a specific clientele right at the point-of-sale in the selected venues. To this end, the present invention effectively addresses this need.

### SUMMARY OF THE INVENTION

A general object and advantage of the present invention is to provide an improved advertising network and system for interconnecting a plurality of venues through an interconnected and linked network, which effectively pairs together buyers and sellers of advertising space, and through which advertisers and marketers can establish a shared resource and a marketplace for exchanging content and advertising space.

A further object and advantage of the present invention is to provide an improved advertising network and system, whereby an advertiser can identify, pinpoint and direct an advertising display towards a specific subset of display screens or display panels at selected ones of the plurality of venues in the network with a view to catering to a specific clientele in the selected venues.

According to one aspect of the present invention, there is provided a system for providing targeted advertising in a network, the system comprising interconnecting a plurality of venues through the network, each of the venues having means for displaying one or more advertisements to a plurality of people; providing means for receiving advertising preferences information from an advertiser; providing means for the advertiser to target a specified segment of the plurality of people from selected venues in the network to receive an advertising display, based on the advertising preferences information; creating the advertising display based on the advertising preferences information that is directed to the specified segment of the plurality of people in the network; and displaying the advertising display to the specified segment of the plurality of people at the selected venues in the network.

According to another aspect of the present invention, there is provided a method for providing targeted advertising in a network, the method comprising: interconnecting a plurality of venues through the network, each of the venues having means for displaying one or more advertisements to a plurality of people; providing means for receiving advertising preferences information from an advertiser; providing means for the advertiser to target a specified segment of the plurality of people from selected venues in the network to receive an advertising display, based on the advertising preferences information; creating the advertising display based on the advertising preferences information that is targeted to the specified segment of the plurality of people in the network; and displaying the advertising display to the specified segment of the plurality of people at the selected venues in the network.

According to yet another aspect of the present invention, there is provided a method for providing targeted advertising in a network, the method comprising the steps of interconnecting a plurality of venues through the network, each of the venues having means for displaying one or more advertisements to a plurality of people; providing means for receiving advertising preferences information from an advertiser; providing means for the advertiser to target a specified segment of the plurality of people at any of the venues in the network to receive an advertising display, based on the advertising preferences information; providing means for creating a ranking each of the plurality of venues in the network according to how each of the venues fulfills the advertising preferences information; providing the ranking of each of the plurality of venues in the network in fulfilling the advertising preferences information to the advertiser as a ranking order; creating the advertising display based on the advertising preferences information that is targeted to the specified segment of the plurality of people at selected venues in the network; and displaying the advertising display to the specified segment of the plurality of people at the selected venues in the network.

In essence, the advertising network and system of the present invention is a venue-oriented network, which is fundamentally based on the loose coupling of venues being able to power their own public information displays and ad content and can, at their sole discretion, establish relationships with marketers either on a one-to-one basis, or en masse by joining a program or using a value-added service. Such public information displays can include, but are not limited to, a selection of original custom-created content, one or more subscriptions to third party content (including advertisements), and additional data-driven functionality like news feeds, online video playlists, and so forth. Marketers, also, can take up accounts and establish relationships with venues on a one-to-one basis, or en masse, to create, or port, content on the system and, through these relationships, establish technical connections with each venue in order to have this content distributed to any local public information display screen or panel.

In this manner, the present invention provides an improved advertising network and system through which advertisers and marketers can identify and access local, nuanced display screens and screenscapes both directly through point-to-point relationships and en masse through value-added programs and services.

### BRIEF DESCRIPTION OF THE DRAWINGS

A preferred embodiment of the present invention is described below with reference to the accompanying drawings, in which:

FIG. 1 illustrates a flowchart, in accordance with an embodiment of the present invention;

FIG. 2 is a diagram of one possible Internet embodiment of a hardware configuration for which the present invention could be applied; and

FIG. 3 is a diagram illustrating a possible searching component consistent with an aspect of the present invention.

### DESCRIPTION OF THE PREFERRED EMBODIMENT

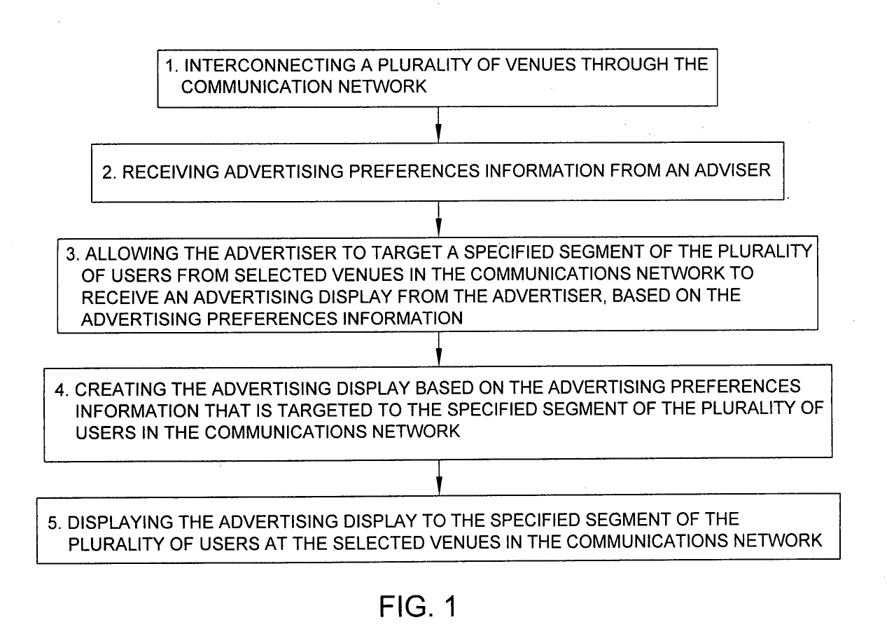

In a preferred embodiment, the present invention essentially provides an improved advertising system and method which is able to interconnect a plurality of public gathering places or facilities (“venues”), and which pairs buyers and sellers of advertising space, whereby an advertiser can identify, pinpoint and direct an advertising display towards a specific subset of display screens or display panels at selected ones of the plurality of venues in the network pinpoint with a view to catering to a specific clientele right at the point-of-sale in the selected venues, and thus focusing their marketing efforts thereto. FIG. 1 is a flow chart illustrating operation of the advertising system and method consistent with one aspect of the present invention.

It will of course be understood that any facility that doubles as a public gathering place could be considered a venue in the context of the present invention, as would be clear to one skilled in the art. It will also be understood that a display screen or display panel, as used in the context of the present invention, refers to a public information display that is meant for the purposes of communicating to the public at that venue. This can include, but is not limited to, flat screen displays, televisions, computer monitors or monitors, or the like.

The present invention is designed to interconnect a plurality of venues through an interlinked network, as a network based community. This is preferably done through the venues subscribing to become members of that network based community, but is not absolutely essential. This provides a viral network and collective of venues interconnecting to establish a shared resource and a marketplace for exchanging content and ad space amongst its membership. It will, of course, be understood that as more venues participate in the network the value of the network builds exponentially, with each member thus helping to make the service more attractive to marketers, and more potentially lucrative as an installed base of potential customers. In essence, the more members of the network means a greater number of people that are potentially accessible for exposure to display screens and display panels in each of the venues of the advertising network.

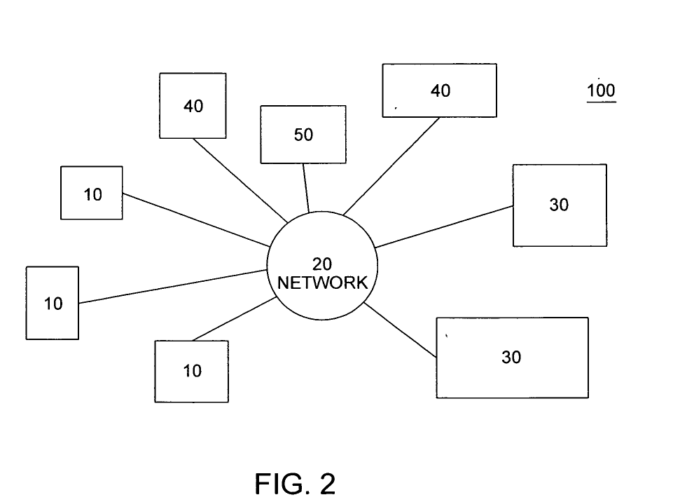

FIG. 2 is a block diagram of an example of the advertising system 100 through which the present invention may be implemented, though it will be understood that variations to this, in terms of setup and arrangement, are possible. Generally speaking, system 100 includes a number of public gathering places or facilities (“venues”) 10 that are members of a network based community, and which are linked to one another by means of a network 20, it being understood that the venues 10 are connected to one or more servers 50 via the network 20. It will also be understood that the term, “network” as used in the context of the present invention, can refer to a wired network, the Internet, a wireless network, a cellular telephone network, a telecommunications network or a mobile network, for use in conjunction with devices designed to operate on these platforms, such as wireless devices, televisions, monitors, mobile/telephone devices, or any other apparatuses or platform configurations, as would be apparent to one skilled in the art. It is also conceivable that the present invention could be utilized in conjunction with a television environment, and that the network may include a local area network (LAN), a wide area network (WAN), a telephone network, such as the Public Switched Telephone Network (PSTN), an intranet, the Internet, or a combination of networks.

In the context of the present invention, it is also conceivable that the “network” could comprise and link together a plurality of venues in a specific geographic location, such as, for example, Boston, as a local network, and that this local network could be interconnected and linked to one or more other local networks in other geographic locations. Thus, an extensively linked national and globally linked advertising network, in an alternative embodiment of the present invention, is possible, the linking of such networks to one other being accomplished through conventional means, as would be apparent to one skilled in the art.

In a preferred embodiment, one or more network administrators 30 will also be connected to, and thus have access, the network 20. In this manner, the one or more network administrators 30 will be able to provide targeted advertising displays and marketing material from or for advertisers to be broadcast over the network 20 to specific display panels and screens (not shown) at selected venues 10, depending, as noted previously, on the advertising preferences of the advertiser, with a view to directing and concentrating their advertising efforts to a specific clientele in the selected venues, as will hereinafter be described.

It is also conceivable that advertisers 40 can have access to the network 20, as shown in FIG. 2, whereby advertisers can create targeted advertising displays and marketing materials for broadcast over the network 20 to specific display panels and screens (not shown) at selected venues 10, it being understood that advertisers 40 are entities that wish to broadcast advertisements, advertising displays or marketing materials to one or more venues 10 on the network 20. However, in a preferred embodiment, advertisers will create or conceive of the targeted advertising displays or marketing materials, and this will be provided to network administrators 30, who will then effect broadcast of the advertising display or marketing materials over the network 20.

In an alternative embodiment, venue managers at each of the venues 10 can receive the targeted advertising displays or marketing materials from advertisers (or create, edit and maintain these materials) and the venue managers will then effect broadcast of the advertising display or marketing materials over the network 20, whether to the venue at which the venue manager is located, or to numerous selected venues in the network 20.

In the example shown in FIG. 2, three venues 10, two network administrators 30, two advertisers 40 and one server 50 have been illustrated as being connected to network 20 for simplicity, though, in practice, there may be more or fewer venues 10, network administrators 30, advertisers 40 and servers 50 connected to network 20.

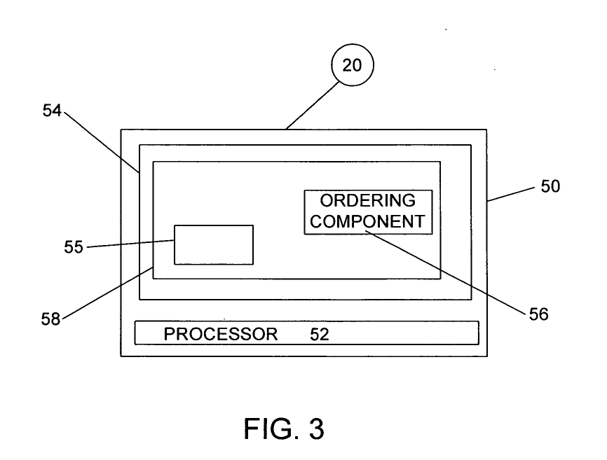

Similar to the client devices noted above, and as noted in FIG. 3, server 50 may include a processor 52 coupled to a computer-readable memory 54, it being understood that server 50 may additionally include a secondary storage element, such as a database (not shown), as would be apparent to one skilled in the art. Such a database may have saved thereon, for example, pertinent information regarding each of the venues 10 on the network 20. This information may include, but is not limited to, demographic information from each venue concerning primary and secondary audiences, age group of such audience, lifestyle, ratio of male to female, secondary audiences, location of venue, locations of display panels and screens at each of the venues, and the like. Client processors (not shown) and server processor 52 can be any of a number of well known computer processors. In general, client devices may be any type of computing platform connected to a network and that interacts with application programs, such as a digital assistant or a “smart” cellular telephone or the like. It will be understood that server 50, although depicted as a single computer system in FIGS. 2 and 3, may be implemented as a network of computer processors, as would be apparent to one skilled in the art.

### In Operation

In utilizing the advertising system and network of the present invention, an advertiser, through either their own contact to network 20, or through contact via a network administrator 30 or venue manager (as noted previously) will access the network 20 through one or more servers 50 connected thereto.

Server 50 may operate as, for example, a network server and include search engine 58. In one implementation, search engine 58 may function as a query-based search engine, to locate relevant information in response to search queries. In response to client requests, search engine 58 may return information to users (hereinafter referred to as “clients”) of the network 20, whether they be advertisers 40, administrators 30 or venues 10, by returning a list of relevant information to the client, which relate to relate to information regarding venues connected to network 20.

The client requests being provided through search engine 58 would comprise information criteria, whereby an advertiser can identify, pinpoint and direct an advertising display towards a specific subset of display screens or display panels at selected venues (or screens at these locations) in the communications network with a view to catering to a specific clientele right at the point-of-sale in the selected venues, thus focusing their marketing efforts thereto. The information criteria entered into the search engine, as noted previously, could comprise, but is not limited to, demographic information from each venue concerning primary and secondary audiences, age group of such audience, lifestyle, ratio of male to female, secondary audiences, location of venue, locations of display panels and screens at each of the venues, and the like.

For example only, an advertiser may wish to tailor an advertising display or marketing materials to venues having a high proportion of a male 18-24 age group, and being predominantly sports oriented. The information may be returned to clients as a listing of venues where this particular demographic is found to be most prevalent. This list of links may be ranked and displayed in an order based on the search engine's determination of relevance to the search query.

Search engine 58 includes a venue criteria locator 55 and an ordering component 56. In general, venue criteria locator 55 locates information whose contents match a user search query. Ordering component 56 may rank the located information based on relevance and may generate a relevance score for each document that indicates a level of relevance. Ordering component 56 assists search engine 58 in returning relevant information to the user by placing in order and ranking the set information identified by venue criteria locator 55. This ranking may take the form of assigning a numerical value, such as a pertinency score, corresponding to the calculated relevance of each piece of demographic criteria identified by venue criteria locator 55. There are a number of suitable ranking algorithms known in the art, and, as such, will not be described further herein.

Once the pertinent venues on the network 20 have been located by the advertiser, a targeted advertising display can be created and directed to these specific venues having the desired demographic sought by the advertiser. Then, broadcasting of this tailored advertising display to these venues can be co-ordinated and effected through conventional means, as known to persons skilled in the art, it being understood that such an advertising display could comprise a plurality of advertisement, a slide slow of various advertisements, or the like. As noted previously, the advertising network of the present invention can be utilized by an advertiser or marketer to identify, pinpoint and direct a specific targeted advertising display towards a specific subset of display screens or panels at selected venues in the network with a view to catering to a specific clientele in these venues, if so desired.

It will be understood that entities accessing the network 20 will be utilizing client devices (not shown), which may include a wireless telephone, a personal computer, a personal digital assistant (PDA), a lap top, or another type of computation or communication device, a thread or process running on one of these devices, and/or an object executable by one of these devices. Such client devices will each include a computer-readable medium, such as random access memory, coupled to a processor, for executing program instructions stored in memory, as would be readily apparent to one skilled in the art. Client devices may also include a number of additional external or internal devices, such as, without limitation, a mouse, a CD-ROM, a keyboard, and a display. Of course, through such client devices, entities can communicate over network 20, and with other systems and devices coupled to network 20.

It will be apparent to one of ordinary skill in the art that aspects of the invention, as described above, may be implemented in many different forms of software, firmware, and hardware in the implementations illustrated in the figures. The actual software code or specialized control hardware used to implement aspects consistent with the present invention is not limiting of the present invention. Thus, the operation and behavior of the aspects were described without reference to the specific software code, it being understood that a person of ordinary skill in the art would be able to design software and control hardware to implement the aspects based on the description herein.

The present invention has been described herein with regard to preferred embodiments. However, it will be obvious to persons skilled in the art that a number of variations and modifications can be made without departing from the scope of the invention as described herein.

The embodiments of the invention in which an exclusive property or privilege is claimed are defined as follows:

1. A system for providing targeted advertising in a network, the system comprising:
interconnecting a plurality of venues through the network, each of the venues having means for displaying one or more advertisements to a plurality of people;
providing means for receiving advertising preferences information from an advertiser;
providing means for the advertiser to target a specified segment of the plurality of people from selected venues in the network to receive an advertising display, based on the advertising preferences information; and
displaying the advertising display to the specified segment of the plurality of people at the selected venues in the network.

2. The system of claim 1, wherein the network is the Internet.

3. The system of claim 1, wherein the network is a wired network, a wireless network, a cellular telephone network, a telecommunications network or a mobile network.

4. The system of claim 1, wherein the network is a local area network (LAN), a wide area network (WAN), a telephone network, such as the Public Switched Telephone Network (PSTN), an intranet, the Internet, or a combination of interconnected and linked networks.

5. The system of claim 1, wherein the means for displaying the one or more advertisements to the plurality of people is at least one image display screen located at each of the venues.

6. The system of claim 1, wherein the at least one screen is a computer monitor, a monitor, a display panel, a mobile telephone, cellular device, or television.

7. The system of claim 1, wherein the advertising display comprises a plurality of advertisements.

8. The system of claim 4, wherein the network can be interconnected and linked to other interconnected and linked networks.

9. The system of claim 1, wherein each of the plurality of venues subscribe to become members of the network.

10. The system of claim 1, wherein the advertising display is forwarded to one or more network administrators for broadcast at the selected venues in the network

11. The system of claim 1, wherein the advertising display is created by one or more network administrators for broadcast at the selected venues in the network.

12. The system of claim 8, wherein the advertising display is displayed to the specified segment of the plurality of people at selected venues in the network and the other interconnected and linked networks.

13. The system of claim 1, wherein the advertising preferences information comprises demographic information concerning primary and secondary audiences at each of the venues, age group of the primary and secondary audiences at each of the venues, lifestyle information of the plurality of people at each of the venues, ratio of male to female at each of the venues, location of each of the venues, and locations of display panels and screens at each of the venues.

14. The system of claim 1, further comprising providing means for ranking each of the plurality of venues in the network according to how each of the venues fulfills the advertising preferences information.

15. The system of claim 1, the ranking of each of the plurality of venues in the network in fulfilling the advertising preferences information is provided to the user as a ranking order.

16. The system of claim 1, wherein the ranking order is implemented by a programmed computer.

17. A method for providing targeted advertising in a network, the system comprising:
interconnecting a plurality of venues through the network, each of the venues having means for displaying one or more advertisements to a plurality of people;
providing means for receiving advertising preferences information from an advertiser;
providing means for the advertiser to target a specified segment of the plurality of people from selected venues in the network to receive an advertising display, based on the advertising preferences information;
creating the advertising display based on the advertising preferences information that is targeted to the specified segment of the plurality of people in the network; and
displaying the advertising display to the specified segment of the plurality of people at the selected venues in the network.

18. The method of claim 17, wherein, after the step of creating the advertising display, the advertising display is forwarded to one or more network administrators for broadcast at the selected venues in the network.

19. The method of claim 17, further comprising the step of interconnecting and linking the network to other interconnected and linked networks.

20. A method for providing targeted advertising in a network, the system comprising:
interconnecting a plurality of venues through the network, each of the venues having means for displaying one or more advertisements to a plurality of people;
providing means for receiving advertising preferences information from an advertiser;
providing means for the advertiser to target a specified segment of the plurality of people at any of the venues in the network to receive an advertising display, based on the advertising preferences information;
providing means for creating a ranking each of the plurality of venues in the network according to how each of the venues fulfills the advertising preferences information;
providing the ranking of each of the plurality of venues in the network in fulfilling the advertising preferences information to the advertiser as a ranking order;
creating the advertising display based on the advertising preferences information that is targeted to the specified segment of the plurality of people at selected venues in the network; and
displaying the advertising display to the specified segment of the plurality of people at the selected venues in the network.
